(19) United States
(12) Patent Application Publication
(10) Pub. No.: US 2025/0125855 A1
(43) Pub. Date: Apr. 17, 2025

(54) PARTIALLY NETWORK-CONTROLLED REPEATER

(71) Applicant: QUALCOMM Incorporated, San Diego, CA (US)

(72) Inventors: Tianyang BAI, Mountain View, CA (US); Navid ABEDINI, Basking Ridge, NJ (US); Kapil GULATI, Belle Mead, NJ (US); Junyi LI, Fairless Hills, PA (US)

(21) Appl. No.: 18/487,851

(22) Filed: Oct. 16, 2023

(51) Int. Cl. H04B 7/06; H04B 7/026; H04B 7/155; H04W 24/10; H04W 72/044; H04W 72/1273

(52) U.S. Cl. CPC H04B 7/0695; H04B 7/026; H04B 7/155; H04W 24/10; H04W 72/046; H04W 72/1273

(57) ABSTRACT

Certain aspects of the present disclosure provide techniques for a partially network-controlled repeater. A method for wireless communications by a repeater includes receiving downlink control information (DCI) from a network entity via a backhaul link, the DCI indicating a time period for beam management. The method includes performing a beam management procedure with a user equipment (UE) during the time period. The method includes determining a beam for communicating with the UE based on the beam management procedure. The method includes communicating with the UE using the beam.

### BACKGROUND

### Field of the Disclosure

Aspects of the present disclosure relate to wireless communications, and more particularly, to techniques for a partially network-controlled repeater.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a repeater. The method includes receiving downlink control information (DCI) from a network entity via a backhaul link, the DCI indicating a time period for beam management; performing a beam management procedure with a user equipment (UE) during the time period; determining a beam for communicating with the UE based on the beam management procedure; and communicating with the UE using the beam.

Another aspect provides a method for wireless communications by a user equipment. The method includes performing a beam management procedure with a repeater; detecting a failure of a beam used for communicating with the repeater; and sending a beam failure recovery request (BFRQ) message indicating failure of the beam and indicating a replacement beam.

Another aspect provides a method for wireless communications by a network entity. The method includes outputting downlink control information (DCI) for transmission to a repeater via a backhaul link, the DCI indicating a time period for beam management; configuring one or more resources for the repeater to perform a beam management procedure with a user equipment (UE); and obtaining an indication of a beam used for communications between the repeater and the UE.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example repeater serving a user equipment for a base station.

FIG. 6 depicts a call flow of example signaling between the repeater, user equipment, and base station.

FIG. 7 depicts example coarse and refined beams for communications between the repeater and user equipment.

FIG. 8 depicts an example timeline for tracking reference signals.

FIG. 9 depicts a method for wireless communications.

FIG. 10 depicts a method for wireless communications.

FIG. 11 depicts a method for wireless communications.

FIG. 12 depicts aspects of an example communications device.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for a partially network-controlled repeater.

A repeater may be a relatively low complexity device that enhances coverage of the network by amplifying and forwarding signals between a base station and a user equipment. Current repeaters may be fully network-controlled. For example, the base station may send control information to the repeater configuring the repeater's amplify and forward including beamforming at the repeater. However, the network may not have the full and real time picture of the repeater to UE channels, and the instructed behavior may be out of date. In addition, the fully network-controlled repeater may add high overhead to the base station in controlling the operations of the repeater.

According to certain aspects, a repeater may be only partially network-controlled. A partially network-controlled repeater may make certain decisions on its own (e.g., without control or instructions from the base station), such as beam management decisions.

In some aspects, the partially network-controlled repeater associated a UE and a repeater and configures some resources for performing a beam management procedure, and then the repeater and UE perform beamsweeping and autonomous beam selection without involvement/control from the base station. In addition, in some aspects, the repeater and UE can perform beam switching, beam refinement, and beam failure recovery without involvement/control from the base station.

In some aspects, the repeater measures reference signals (RSs) from the UE and selects a downlink beam to use for communicating with the UE or the repeater decodes a measurement report from the UE to select the downlink beam for communicating with the UE. In some aspects, the repeater uses a machine learning model to predict a best downlink beam for communicating with the UE.

In some aspects, for beam failure recovery, the repeater decodes a beam failure recovery request message from the UE that indicates a replacement beam for the repeater. The repeater may switch to the replacement beam, or message the base station to send downlink control information (DCI) to switch the beam.

In some aspects, the beam management procedure is used to select a coarse beam and/or a narrow beam. In some aspects, the beam management procedure is used to select a transmit beam and/or a receive beam at the repeater. In some aspects, the beam management procedure is used to select a transmit beam and/or a receive beam at the UE.

In some aspects, the repeater and the UE can switch refined beams without base station involvement. In some aspects, the base station may be involved to send a DCI for switching a coarse beam. In some aspects, when the repeater changes its downlink narrowbeam, the UE may refine the UEs time/frequency tracking and/or the UEs receive beam. In some aspects, the repeater may tell the base station when the repeater has changed the downlink repeater beam. In some aspects, when the repeater has changed the downlink repeater beam, the repeater can transmit a tracking reference signal (TRS) and/or a channel state information reference signal (CSI-RS) using the new beam.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

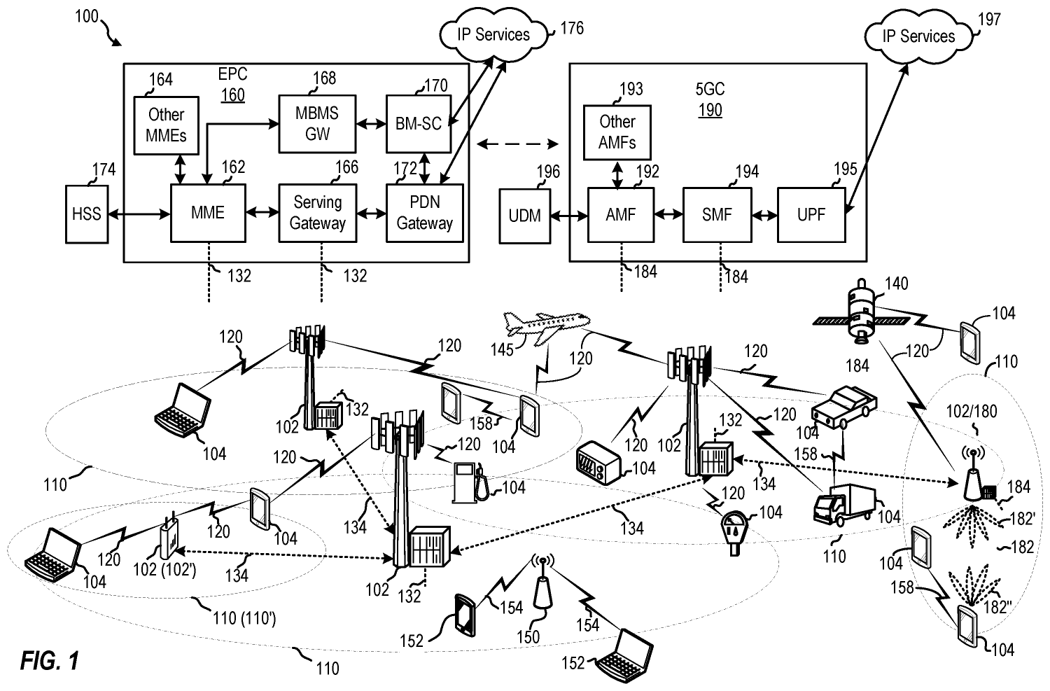

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

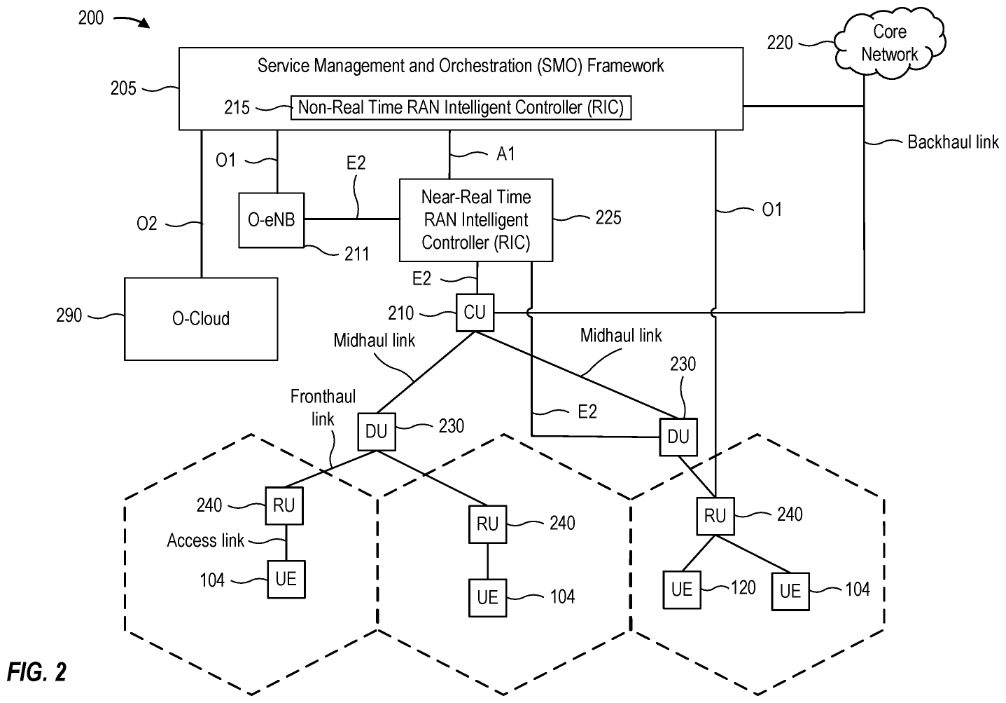

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

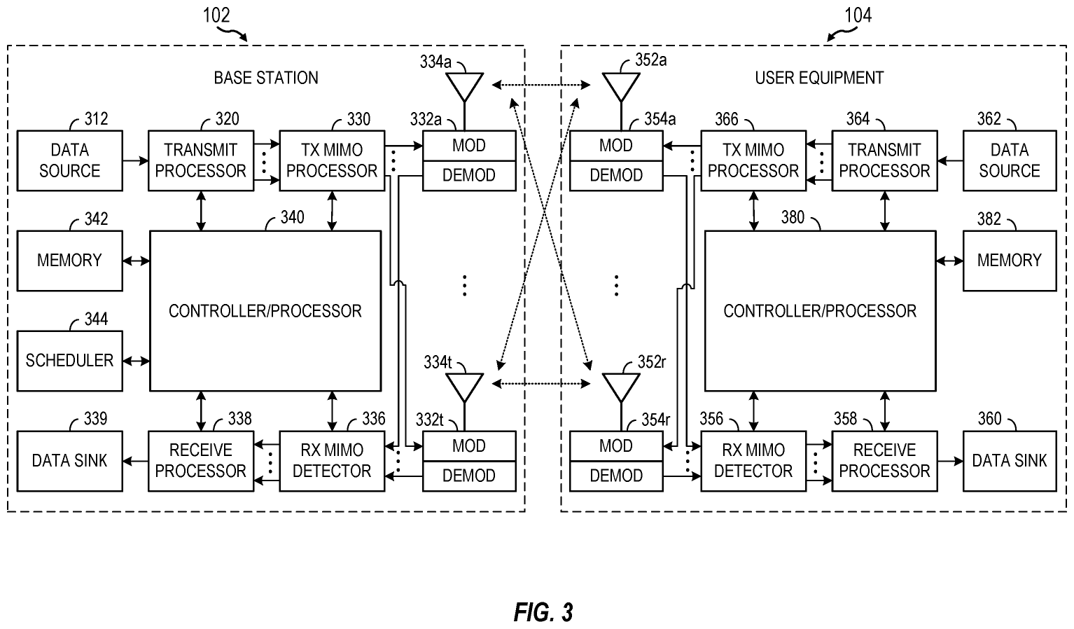

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

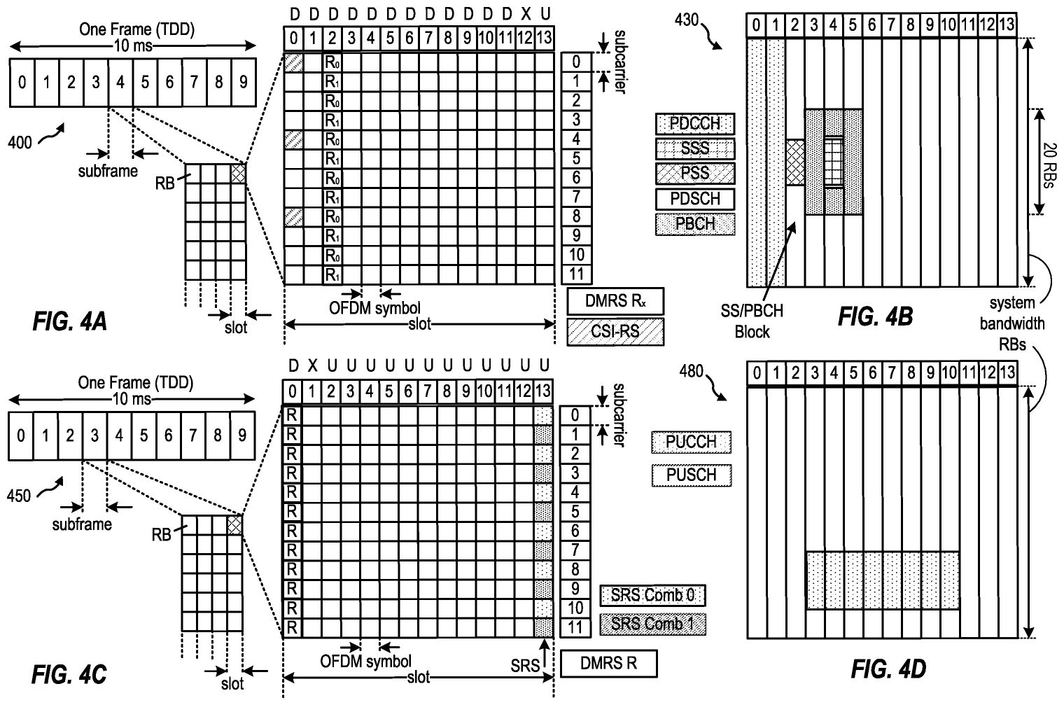

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to a Partially Network-Controlled Repeater

To improve the coverage and support the increasing number of user equipments (UEs), different methods are considered, among which network densification and millimeter wave (mmw) communications are considered important contributions. Network densification refers to the deployment of multiple access points of different types (e.g., in metropolitan areas. Small nodes, such as relays, integrated access and backhaul (IAB), reconfigurable intelligent surfaces (RIS), and repeaters, may be deployed to assist the communications.

In certain systems, such as 3GPP 5G NR Release 16 and Release 17 systems, IAB nodes are specified as the main relaying nodes. While IAB nodes extend coverage, IAB are, however, relatively complex.

A RIS may be an electromagnetically active artificial structures with low beamforming capabilities, and hence low accuracy, that can be used to reshape the propagation environment such as to improve capacity, coverage and energy efficiency. A RIS may control electromagnetic properties of the RF waves by performing an intelligent adaptation of the phase shift (e.g., adapting a phase matrix) towards the desired direction, without performing any decoding.

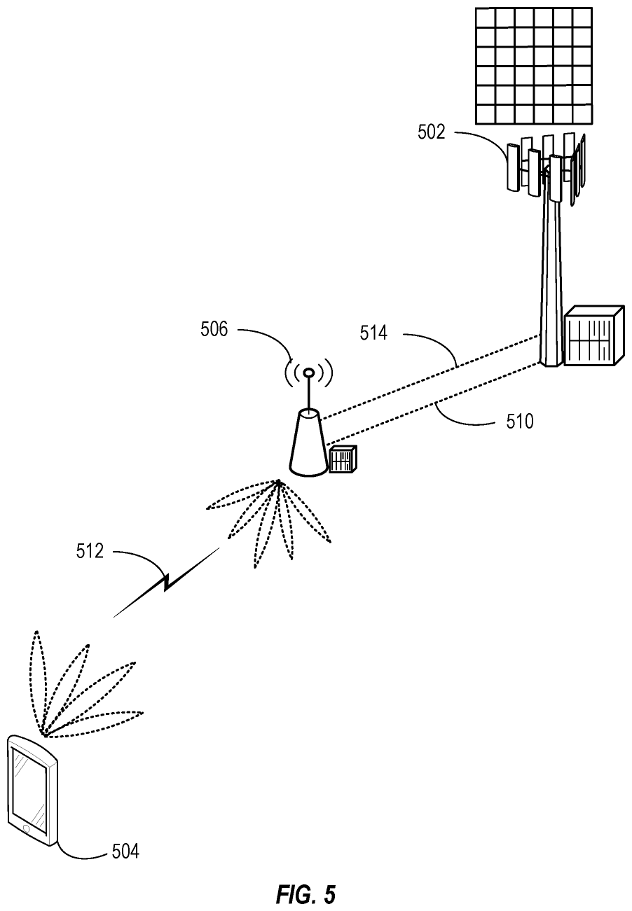

Repeaters (e.g., RF repeaters), on the hand, enhance coverage, but are low complexity devices, significantly reducing operator costs. FIG. 5 depicts an example repeater 506 serving a user equipment 504 (e.g., such as a UE 104 of FIG. 1) for a base station 502 (e.g., such as a BS 102 of FIG. 1). The repeater 506 may communicate with the base station 502 over a backhaul link 510 (and/or control link 514, such as a Uu link) and with the user equipment 504 via an access link 512. In some aspects, repeater 506 includes a mobile termination (MT), a functional entity to communicate with base station 502 via a control link. The repeater 506 may include a forward functional entity to perform the amplify-and-forwarding operation of uplink and downlink RF signals between the base station 502 and the UE 504. In some aspects, the repeater 506 can maintain the base station-repeater link 510 simultaneously with the repeater-user equipment link 512.

Currently, such repeaters are fully network-controlled. A network-control repeater (NCR) may amplify-and-forward signals it receives without performing any decoding. An NCR may use transmit and receive beamforming to control interference. An NCR may receive and process control information from the base station that configures the NCR's amplify and forward operations. Thus, the NCR can be logically a part of the base station for management purposes. In some aspects, NCRs are in-band RF repeaters used for extension of network coverage in the FR1 and FR2 bands and may operate transparently to the UE. After power amplification and with beamforming, the NCR forwards a received RF signal in the uplink or downlink. Since the NCR-forward only amplifies and beamforms the RF signal, the NCR may not use any advanced digital receiver or transmitter chains.

NCRs may lack in accurate beamforming as NW side may not have the full and real time picture of the repeater to UE channels, and the instructed behavior may be out of date. Thus, the instructed repeater beam may not be the best beam at the moment when the repeater applies the beam, due to the delay in forwarding the report.

Further, NCRs may add overhead to the base station in controlling the operations of the repeater, for example the beam management and beam measurement for the beamforming are fully controlled by the network for the NCR.

According to certain aspects, a repeater may be only partially network-controlled. A partially network-controlled repeater may make certain decisions on its own (e.g., without control or instructions from the base station), such as beam management decisions. In some aspects, the partially network-controlled repeater associated a UE and a repeater and configures some resources for performing a beam management procedure, and then the repeater and UE perform beamsweeping and autonomous beam selection without involvement/control from the base station. In addition, in some aspects, the repeater and UE can perform beam switching, beam refinement, and beam failure recovery without involvement/control from the base station.

### Example Operations of Entities in a Communications Network

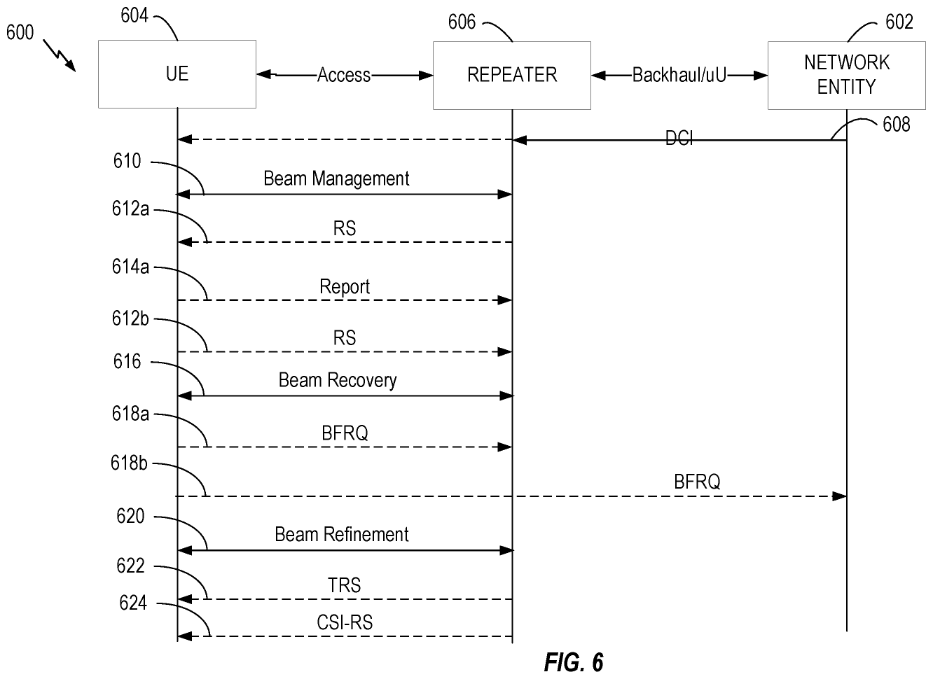

FIG. 6 depicts a process flow 600 for communications in a network between a network entity 602, a user equipment 604, and a repeater 606. In some aspects, the network entity 602 may be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. Repeater 606 may be a partially network-controlled repeater. However, in other aspects, UE 604 may be another type of wireless communications device, network entity 602 may be another type of network entity or network node, and repeater 606 may another type of repeater, such as those described herein.

As shown, at operation 608, the network entity 602 may send downlink control information (DCI) to repeater 606. For example, the network entity 602 may send the DCI to repeater 606 via the backhaul or control link. In some aspects, the network entity 602 associates the UE 604 and the repeater 606. For example, the network entity 602 may configure the repeater 606 to serve the UE 604. The DCI may allocate a time period for repeater 606 and UE 604 to perform beam management. The repeater 606 may forward the DCI to the UE 604.

At operation 610, the UE 604 and the repeater 606 may perform a beam management procedure. In some aspects, the beam management procedure includes a beam pair link selection procedure (e.g., a P1 procedure) and/or a beam refinement procedure (e.g., a P2 or P3 procedure). As shown in FIG. 6, optionally, performing the beam management procedure may include operation 612a, in which the repeater 606 transmits RSs to the UE 604 using different transmit beams of the repeater 606 with downlink beamsweeping (e.g., in the time period configured by the network entity 602). The UE 604 measures the RSs and sends a report at operation 614a. In some aspects, the UE 604 sends the report in a PUCCH resource. The PUCCH resource for sending the report may be configured by the network entity 602. In some aspects, the UE 604 sends the report to the repeater 606 as shown in FIG. 6. In some aspects, the UE 604 sends the report to the network entity 602 and the network entity 602 then forwards the report to the repeater 606. In some aspects, the report (e.g., when send to the network entity 602) includes measurements of RSs from multiple different repeaters. In some aspects, the network entity 602 forwards the report to the corresponding repeater. In some aspects, based on the report, the repeater 606 determines a downlink beam to use for serving the UE 604. In some aspects, the UE 604 indicates the beam in the report.

As shown in FIG. 6, optionally, performing the beam management procedure may include operation 612b, in which the UE 604 transmits RSs to the repeater 606 using different transmit beams of the UE 604 with uplink beamsweeping (e.g., in the time period configured by the network entity 602). In some aspects, the RSs are sounding reference signals (SRSs). The repeater 606 measures the RSs. In some aspects, based on the measurements, the repeater 606 determines a downlink beam to use for serving the UE 604.

In some aspects, when the network entity 602 schedules a transmission, such as PDSCH or PDCCH, the network entity 602 indicates to the repeater 606 that the transmission is for the UE 604, such that the network entity 602 can use the corresponding beam determined for the UE 604 for forwarding the transmission to the UE 604. In some aspects, the network entity 602 indicates a logical identifier (ID), a configuration ID, and/or a UE ID.

According to certain aspects, the network entity 602, the repeater 606 and/or the UE 604 selects a beam for communication between the repeater 606 and the UE 604 using machine learning. In some aspects, a machine learning algorithm is used to generate a beam prediction model. The beam prediction may run at the network entity 602, the repeater 606 and/or the UE 604 for selecting the beam. In some aspects, the network entity 602 provides beam training information to repeater 606 and/or the UE 604. In some aspects, the beam training information includes prior measurements from other nodes. In some aspects, the network entity 602, the repeater 606 and/or the UE 604 gathers beam training data from the network entity 602, the repeater 606 and/or the UE 604. In some aspects, the network entity 602 configures a measurement gap at the repeater 606 and/or the UE 604 for the repeater 606 and/or the UE 604 to perform beamsweeping and measurement reporting to train the machine learning beam prediction model. During the measurement gap, the network entity 602 does not schedule any communications for the repeater 606 and UE 604. In some aspects, the repeater 606 requests CSI resources from the network entity 602 for performing beamsweeping.

When the UE 604 detects a failure of a beam, the UE 604 and repeater 606 may perform a beam failure recovery procedure at operation 616. As shown in FIG. 6, the beam failure recovery procedure may include, at operation 618, the UE 604 sending a beam failure recovery request (BFRQ) message. The BFRQ message indicates the beam failure detection and indicates a replacement beam. In some aspects, the BFRQ message is in a random access channel (RACH) message. In some aspects, the BFRQ message is in a PUCCH.

In some aspects, the UE 604 sends the BFRQ message to the repeater 606 at operation 618a. In some aspects, the UE 604 sends the BFRQ message to the network entity 602 at operation 618b. In some aspects, the UE 604 sends the BFRQ message to the network entity 602 and the repeater 606 at operation 618b.

In some aspects, the replacement beam is another beam of the repeater 606. In some aspects, the replacement beam is a beam of a different repeater.

In some aspects, the repeater 606 uses only a single component carrier (CC). In some aspects, the repeater 606 uses multiple CCs.

According to certain aspects, where the repeater 606 uses a single CC, if the replacement beam is from the same repeater 606, then if the UE 604 sends the BFRQ message to the network entity 602 only, then the network entity forward the BFRQ message to the serving repeater 606.

According to certain aspects, where the repeater 606 uses the single CC, and the replacement beam is from the same repeater 606, the UE 604 may send the BFRQ message to the repeater 606. In some aspects, the UE 604 sends a random access channel (RACH) message for the replacement beam. In some aspects, when the UE 604 sends the BFRQ message to the repeater 606, the repeater 606 decodes the BFRQ message, prepares the replacement beam, and forwards the BFRQ to the network entity 602. The network entity 602 may stop scheduling the UE 604 and the repeater 606 until the beam is recovered.

According to certain aspects, where the repeater 606 uses the single CC, and the replacement beam is from a different repeater, the UE 604 may send the BFRQ message to the network entity 602 (e.g., with a RACH request for the replacement beam). The network entity 602 may signal the repeater 606 to release the UE 604 and may signal the new repeater to configure the new repeater to server the UE 604 and indicate the replacement beam to the new repeater.

According to certain aspects, where the repeater 606 uses multiple CCs, where the failed beam is on a first CC, the UE 604 may send the BFRQ message on a different CC, to the repeater 606 and/or the network entity 602.

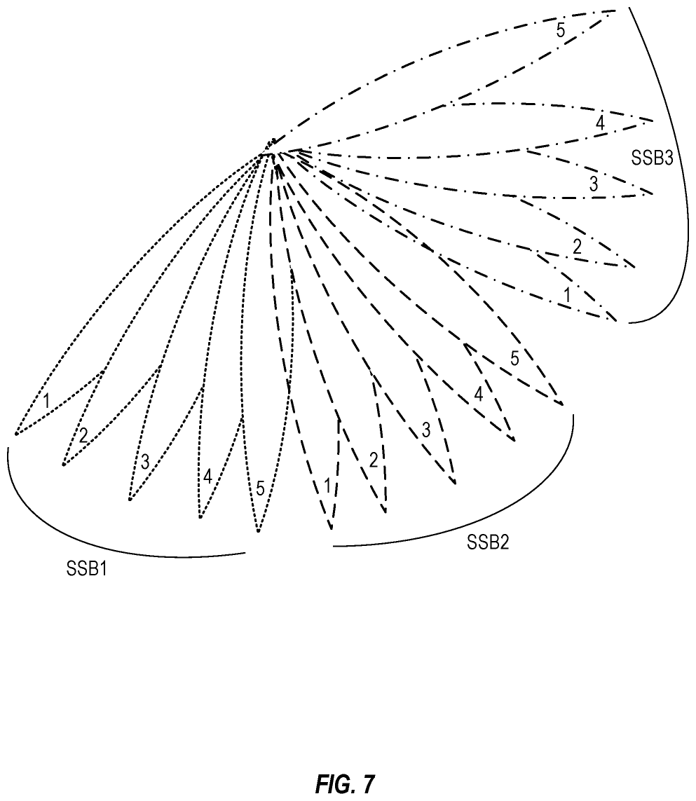

As described herein, the partially network-controlled repeater 606 self-manages the beam management procedure. In some aspects, the repeater 606 determines to change a coarse beam (e.g., a wide beam). For example, as shown in FIG. 7, the coarse SSBs, SSB1, SSB2, and SSB3, may include multiple refined beams (e.g., narrow beams), beams 1-5. In some aspects, when the repeater 606 determines to change the coarse SSB (e.g., from SSB1 to SSB 3 in FIG. 7), the repeater 606 may indicate the new coarse beam to the network entity 602 and the network entity 602 may send DCI to switch to the new coarse beam. However, the repeater 606 may switch the refined beams transparently to the UE 604 and/or the network entity 602.

In some aspects, the UE 604 is configured with resources to monitor periodic tracking reference signal (TRS) and/or periodic channel state information (CSI-RS). In some aspects, instead of the UE 604 being reconfigured with a quasi co-location (QCL) of an RS (e.g., SSB) associated with the same beam as the TRS or CSI-RS, the UE 604 each time the repeater 606 changes the downlink beam, the UE 604 assumed that the beam used for the TRS is the beam used for downlink data. Thus, when the repeater 606 changes the downlink beam, repeater 606 transmits the TRS using the changed beam indicating the change beam to the UE 604 so that the UE 604 can refine its time/frequency tracking and/or the receive beam at the UE 604.

As shown in FIG. 6, the UE 604 and repeater 606 may perform beam refinement at operation 622. Where the beam refinement is to refine the receive beam of the UE 604 (e.g., a P3 procedure), at operation 622, the repeater 606 may transmit TRSs to the UE 604. In some aspects, the refined beam may be dynamic beam which is not from a finite codebook or from a beam from a large codebook. At operation 624, the repeater 606 may transmit CSI-RS to the UE 604 for time and/or frequency tracking. The repeater 606 may transmit anchor refined CSI-RS to the UE 604 for beam tracking. The CSI-RS and TRS may be quasi-colocated (QCL'd) with a same coarse SSB. In some aspects, the TRS and CSI-RS for P3 is always associated with the next in use beam for data (e.g., them beam may be associated with the indicated transmission configuration indicator (TCI) state indicated for a predefined future time).

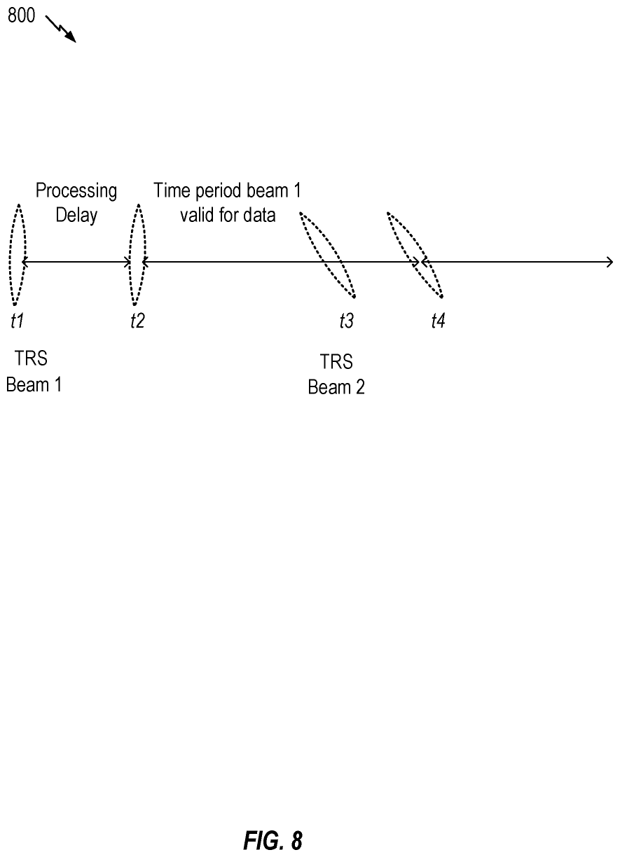

FIG. 8 depicts an example timeline 800 for tracking reference signals. The timeline to apply the measurement from TRSs for refined time/frequency tracking and receive beam may be predefined (e.g., 2 slots). As shown in FIG. 8, at time t1, the repeater may transmit TRS using a first beam (beam 1). After a processing delay, the beam 1 may be valid for a period from a time t2 until a time t4. A refined beam (beam 2) may be determined. The refined beam can be changed without DCI and can be transparent to the UE, as long as corresponding TRS is provided for the UE to perform a P3 procedure to refine its receive beam. The resources and/or the timeline for sending the TRS and for applying the beam may be configured by the network entity 602 for the UE 604 and the repeater 606.

After a DCI triggers a beam switch to a new SSB, the source RS of the TRS may autonomously be switched. The repeater 606 notifies the network entity 602 about SSB switch ahead of time, such that the network entity 602 can send DCI to UE 604 in time. Alternatively, a second TRS may be offered for future SSBs (seamless tracking).

### Example Operations

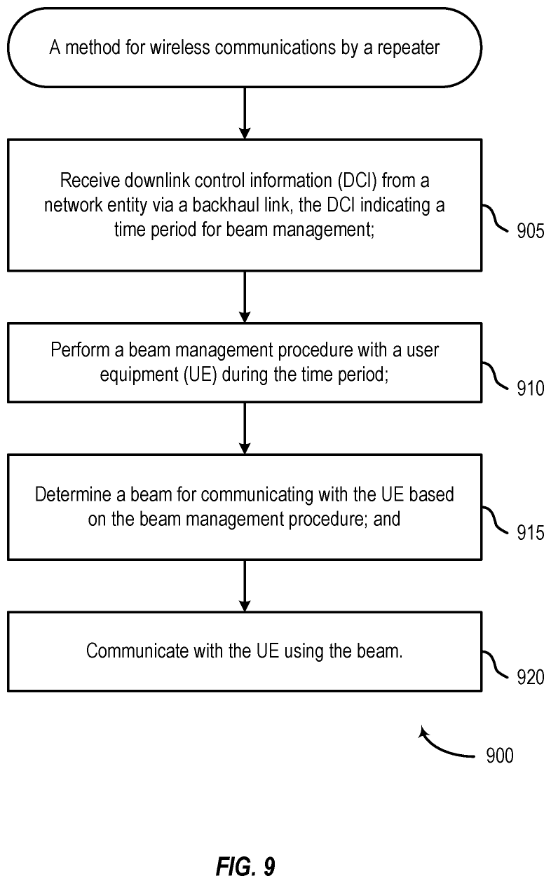

FIG. 9 shows an example of a method 900 of wireless communications by a repeater. In some examples, the repeater is a user equipment, such as a UE 104 of FIGS. 1 and 3. In some examples, the repeater is a network entity, such as a BS 102 of FIGS. 1 and 3, or a disaggregated base station as discussed with respect to FIG. 2.

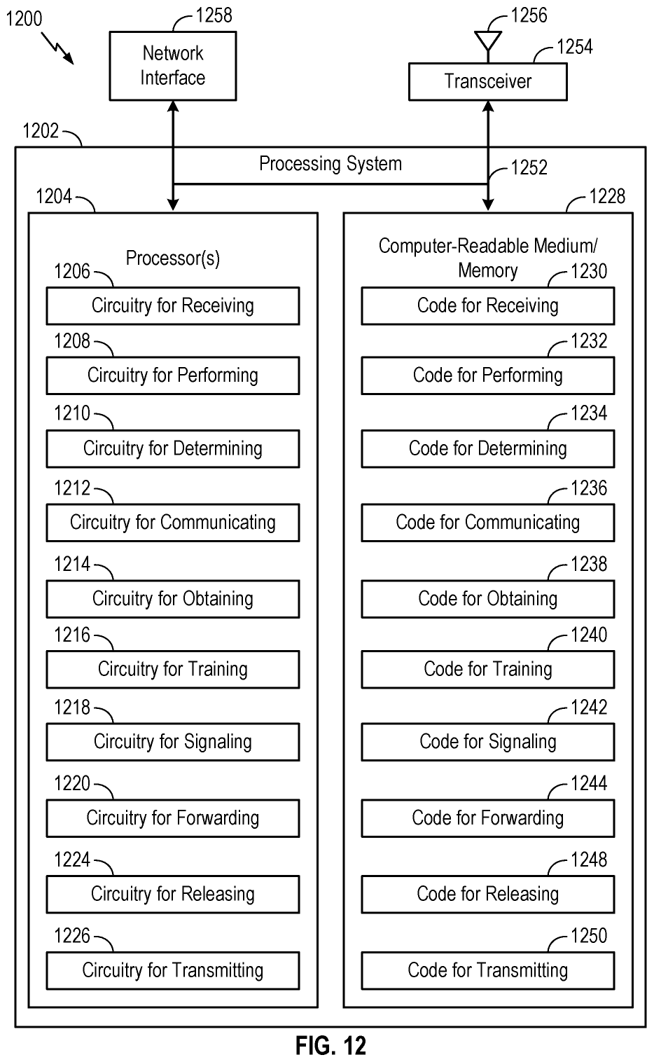

Method 900 begins at step 905 with receiving downlink control information (DCI) from a network entity via a backhaul link, the DCI indicating a time period for beam management. In some cases, the operations of this step refer to, or may be performed by, circuitry for receiving and/or code for receiving as described with reference to FIG. 12.

Method 900 then proceeds to step 910 with performing a beam management procedure with a user equipment (UE) during the time period. In some cases, the operations of this step refer to, or may be performed by, circuitry for performing and/or code for performing as described with reference to FIG. 12.

Method 900 then proceeds to step 915 with determining a beam for communicating with the UE based on the beam management procedure. In some cases, the operations of this step refer to, or may be performed by, circuitry for determining and/or code for determining as described with reference to FIG. 12.

Method 900 then proceeds to step 920 with communicating with the UE using the beam. In some cases, the operations of this step refer to, or may be performed by, circuitry for communicating and/or code for communicating as described with reference to FIG. 12.

In some aspects, performing the beam management procedure with the UE comprises: transmitting signals to the UE during the time period with a plurality of different transmit beams using downlink beam sweeping; and obtaining a report from the UE indicating one or more of the transmit beams; and determining the beam for communicating with the UE comprises determining a downlink beam based on the report from the UE.

In some aspects, obtaining the report from the UE indicating the one or more of the transmit beams comprises receiving the report from the UE in a physical uplink control channel (PUCCH).

In some aspects, obtaining the report from the UE indicating the one or more of the transmit beams comprises receiving the report forwarded by the network entity via the backhaul link.

In some aspects, performing the beam management procedure with the UE comprises measuring signals from the UE during the time period with a plurality of different transmit beams using uplink beam sweeping; and determining the beam for communicating with the UE comprises determining a downlink beam based on the measuring.

In some aspects, the signals from the UE comprises sounding reference signals (SRSs).

In some aspects, the method 900 further includes receiving signaling from the network entity via the backhaul link, the signaling scheduling the repeater to transmit a downlink transmission to the UE, wherein the signaling indicates the UE. In some cases, the operations of this step refer to, or may be performed by, circuitry for receiving and/or code for receiving as described with reference to FIG. 12.

In some aspects, the method 900 further includes communicating with the UE using the beam comprises transmitting the downlink transmission to the UE using the beam based on the signaling indicating the UE. In some cases, the operations of this step refer to, or may be performed by, circuitry for communicating and/or code for communicating as described with reference to FIG. 12.

In some aspects, the signaling indicates the UE via a logical identifier (ID), a configuration ID, or a UE ID associated with the UE.

In some aspects, the determining the beam for communicating with the UE comprises determining the beam using a machine learning model.

In some aspects, the method 900 further includes receiving beam measurement information from the network entity, wherein the determining the beam for communicating with the UE comprises using the machine learning model comprises: inputting the beam measurement information to the machine learning model. In some cases, the operations of this step refer to, or may be performed by, circuitry for receiving and/or code for receiving as described with reference to FIG. 12.

In some aspects, the method 900 further includes obtaining a predicted downlink beam for communicating with the UE from the machine learning model in response to the inputting. In some cases, the operations of this step refer to, or may be performed by, circuitry for obtaining and/or code for obtaining as described with reference to FIG. 12.

In some aspects, the method 900 further includes performing, during one or more measurement gaps, one or more beam management procedures with the UE. In some cases, the operations of this step refer to, or may be performed by, circuitry for performing and/or code for performing as described with reference to FIG. 12.

In some aspects, the method 900 further includes training the machine learning model based on the one or more beam management procedures. In some cases, the operations of this step refer to, or may be performed by, circuitry for training and/or code for training as described with reference to FIG. 12.

In some aspects, the method 900 further includes signaling a request to the network entity for channel state information (CSI) resources for the one or more beam management procedures. In some cases, the operations of this step refer to, or may be performed by, circuitry for signaling and/or code for signaling as described with reference to FIG. 12.

In some aspects, the determining the beam for communicating with the UE comprises: reporting beam training data to the network entity; and receiving signaling from the network entity indicating the beam.

In some aspects, the method 900 further includes obtaining a beam failure recovery request (BFRQ) message from the UE, the BFRQ message indicating failure of the beam and indicating a replacement beam. In some cases, the operations of this step refer to, or may be performed by, circuitry for obtaining and/or code for obtaining as described with reference to FIG. 12.

In some aspects, the replacement beam comprises a second downlink beam of the repeater on a same component carrier as the failed beam.

In some aspects, obtaining the BFRQ message from the UE comprises receiving the BFRQ message forwarded by the network entity.

In some aspects, obtaining the BFRQ message from the UE comprises receiving the BFRQ message from the UE.

In some aspects, the method 900 further includes forwarding the BFRQ message to the network entity. In some cases, the operations of this step refer to, or may be performed by, circuitry for forwarding and/or code for forwarding as described with reference to FIG. 12.

In some aspects, the method 900 further includes sending a random access channel (RACH) response message to the UE using the replacement beam. In some cases, the operations of this step refer to, or may be performed by, circuitry for sending and/or code for sending as described with reference to FIG. 12.

In some aspects, obtaining the BFRQ message from the UE comprises receiving the BFRQ message from the UE on a first component carrier, wherein the failed beam is on a second component carrier.

In some aspects, the method 900 further includes receiving signaling from the network entity indicating for the repeater to release the UE. In some cases, the operations of this step refer to, or may be performed by, circuitry for receiving and/or code for receiving as described with reference to FIG. 12.

In some aspects, the method 900 further includes releasing the UE in response to the signaling. In some cases, the operations of this step refer to, or may be performed by, circuitry for releasing and/or code for releasing as described with reference to FIG. 12.

In some aspects, the method 900 further includes signaling the network entity an indication of the determined beam. In some cases, the operations of this step refer to, or may be performed by, circuitry for signaling and/or code for signaling as described with reference to FIG. 12.

In some aspects, the determined beam comprises a coarse beam, and further comprising determining one or more refined beams within the coarse beam.

In some aspects, the method 900 further includes transmitting one or more channel state information reference signals (CSI-RSs) to the UE as part of a UE receive beam refinement procedure. In some cases, the operations of this step refer to, or may be performed by, circuitry for transmitting and/or code for transmitting as described with reference to FIG. 12.

In some aspects, the method 900 further includes transmitting first one or more phase tracking reference signals (PTRSs) to the UE, wherein the first one or more PTRSs are associated with a first downlink beam for data transmission to the UE. In some cases, the operations of this step refer to, or may be performed by, circuitry for transmitting and/or code for transmitting as described with reference to FIG. 12.

In some aspects, the method 900 further includes transmitting, after determining the beam, second one or more PTRSs to the UE, wherein the second one or more PTRSs are associated with the determined beam. In some cases, the operations of this step refer to, or may be performed by, circuitry for transmitting and/or code for transmitting as described with reference to FIG. 12.

In some aspects, the first one or more PTRSs and the second one or more PTRSs are associated with a same coarse beam.

In some aspects, the method 900 further includes transmitting one or more synchronization signal blocks (SSBs). In some cases, the operations of this step refer to, or may be performed by, circuitry for transmitting and/or code for transmitting as described with reference to FIG. 12.

In one aspect, method 900, or any aspect related to it, may be performed by an apparatus, such as communications device 1200 of FIG. 12, which includes various components operable, configured, or adapted to perform the method 900. Communications device 1200 is described below in further detail.

Note that FIG. 9 is just one example of a method, and other methods including fewer, additional, or alternative steps are possible consistent with this disclosure.

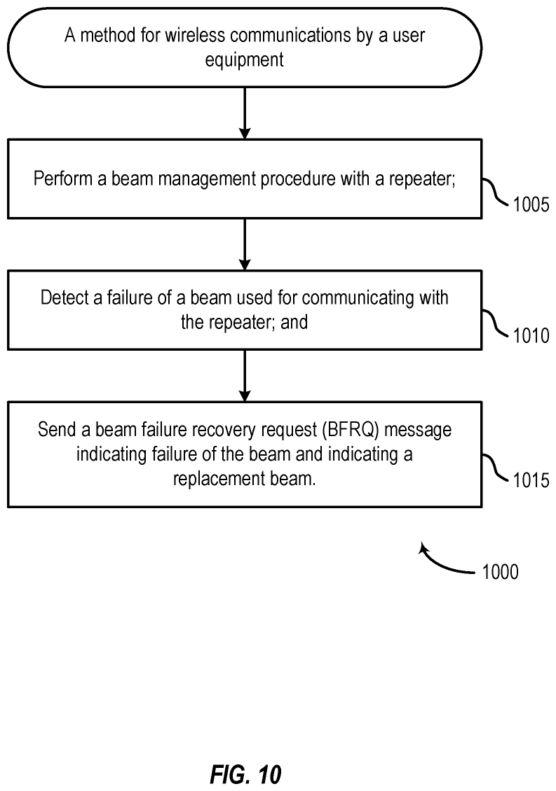

FIG. 10 shows an example of a method 1000 of wireless communications by a user equipment, such as a UE 104 of FIGS. 1 and 3.

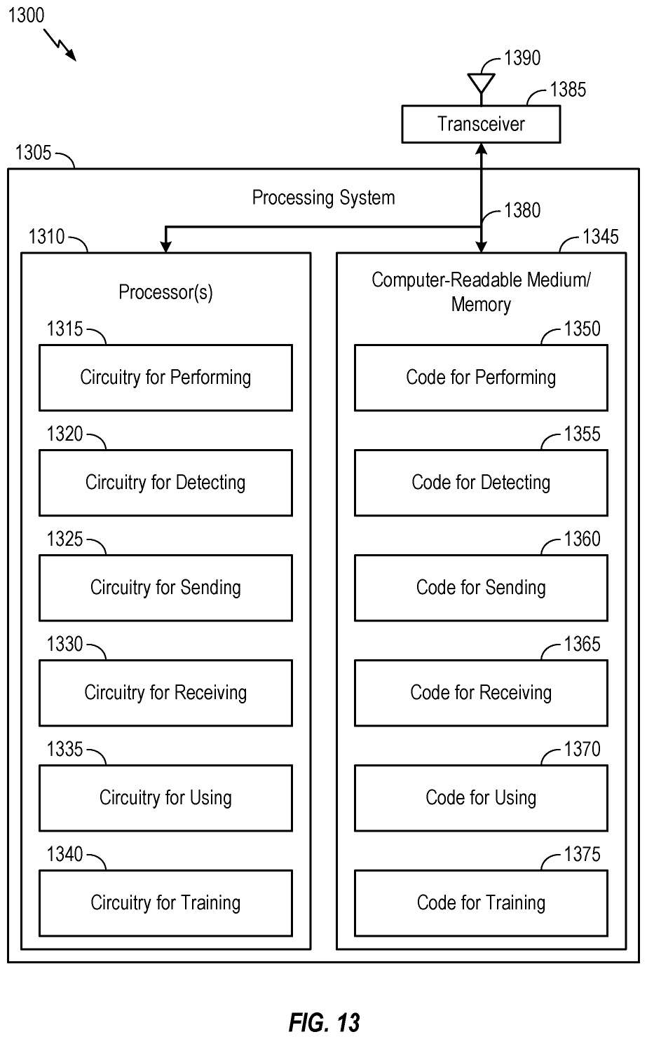

Method 1000 begins at step 1005 with performing a beam management procedure with a repeater. In some cases, the operations of this step refer to, or may be performed by, circuitry for performing and/or code for performing as described with reference to FIG. 13.

Method 1000 then proceeds to step 1010 with detecting a failure of a beam used for communicating with the repeater. In some cases, the operations of this step refer to, or may be performed by, circuitry for detecting and/or code for detecting as described with reference to FIG. 13.

Method 1000 then proceeds to step 1015 with sending a beam failure recovery request (BFRQ) message indicating failure of the beam and indicating a replacement beam. In some cases, the operations of this step refer to, or may be performed by, circuitry for sending and/or code for sending as described with reference to FIG. 13.

In some aspects, performing the beam management procedure with the repeater comprises: receiving signals from the repeater, during a time period, transmitted with a plurality of different transmit beams using a same receive beam; and sending a report indicating one or more of the plurality of different transmit beams.

In some aspects, sending the report comprises sending the report to the repeater.

In some aspects, sending the report comprises sending the report to a base station associated with the repeater.

In some aspects, the report further comprises measurements of beams associated with one or more other repeaters.

In some aspects, sending the report comprises sending the report in a physical uplink control channel (PUCCH).

In some aspects, performing the beam management procedure with the repeater comprises sending signals to the repeater, during a time period, with a plurality of different transmit beams using uplink beam sweeping.

In some aspects, the signals comprise sounding reference signals (SRSs).

In some aspects, performing the beam management procedure includes: inputting beam measurement information to a machine learning model; and obtaining a predicted beam for communicating with the repeater from the machine learning model in response to the inputting.

In some aspects, the method 1000 further includes receiving beam training information from a base station associated with the repeater. In some cases, the operations of this step refer to, or may be performed by, circuitry for receiving and/or code for receiving as described with reference to FIG. 13.

In some aspects, the method 1000 further includes using the beam training information during the beam management procedure to predict a best beam for communicating with the repeater. In some cases, the operations of this step refer to, or may be performed by, circuitry for using and/or code for using as described with reference to FIG. 13.

In some aspects, the method 1000 further includes performing, during one or more measurement gaps, one or more beam management procedures with the repeater. In some cases, the operations of this step refer to, or may be performed by, circuitry for performing and/or code for performing as described with reference to FIG. 13.

In some aspects, the method 1000 further includes training the machine learning model based on the one or more beam management procedures. In some cases, the operations of this step refer to, or may be performed by, circuitry for training and/or code for training as described with reference to FIG. 13.

In some aspects, sending the BFRQ message comprises sending the BFRQ message to the repeater.

In some aspects, the replacement beam comprises a second downlink beam of the repeater on a same component carrier as the failed beam.

In some aspects, the sending the BFRQ message comprises sending the BFRQ message to the repeater on a first component carrier, wherein the failed beam is on a second component carrier.

In some aspects, sending the BFRQ message comprises sending the beam failure message to a base station associated with the repeater.

In some aspects, the method 1000 further includes sending the BFRQ message to the repeater. In some cases, the operations of this step refer to, or may be performed by, circuitry for sending and/or code for sending as described with reference to FIG. 13.

In some aspects, the replacement beam comprises a beam of another repeater.

In some aspects, the method 1000 further includes sending a random access channel (RACH) request message to the other repeater indicating the replacement beam. In some cases, the operations of this step refer to, or may be performed by, circuitry for sending and/or code for sending as described with reference to FIG. 13.

In some aspects, the beam comprises a coarse beam, and further comprising determining one or more refined beams within the coarse beam.

In some aspects, the method 1000 further includes receiving one or more channel state information reference signals (CSI-RSs) from the repeater as part of a UE receive beam refinement procedure. In some cases, the operations of this step refer to, or may be performed by, circuitry for receiving and/or code for receiving as described with reference to FIG. 13.

In some aspects, the method 1000 further includes receiving first one or more phase tracking reference signals (PTRSs) from the repeater, wherein the first one or more PTRSs are associated with a first downlink beam for data transmission to the UE. In some cases, the operations of this step refer to, or may be performed by, circuitry for receiving and/or code for receiving as described with reference to FIG. 13.

In some aspects, the method 1000 further includes receiving second one or more PTRSs from the repeater, wherein the second one or more PTRSs are associated with the determined beam. In some cases, the operations of this step refer to, or may be performed by, circuitry for receiving and/or code for receiving as described with reference to FIG. 13.

In some aspects, the first one or more PTRSs and the second one or more PTRSs are associated with a same coarse beam.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

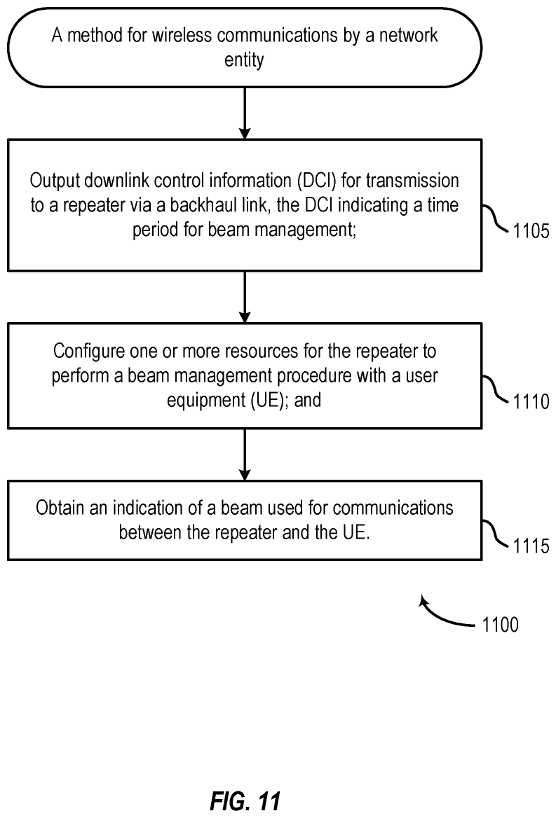

FIG. 11 shows an example of a method 1100 of wireless communications by a network entity, such as a BS 102 of FIGS. 1 and 3, or a disaggregated base station as discussed with respect to FIG. 2.

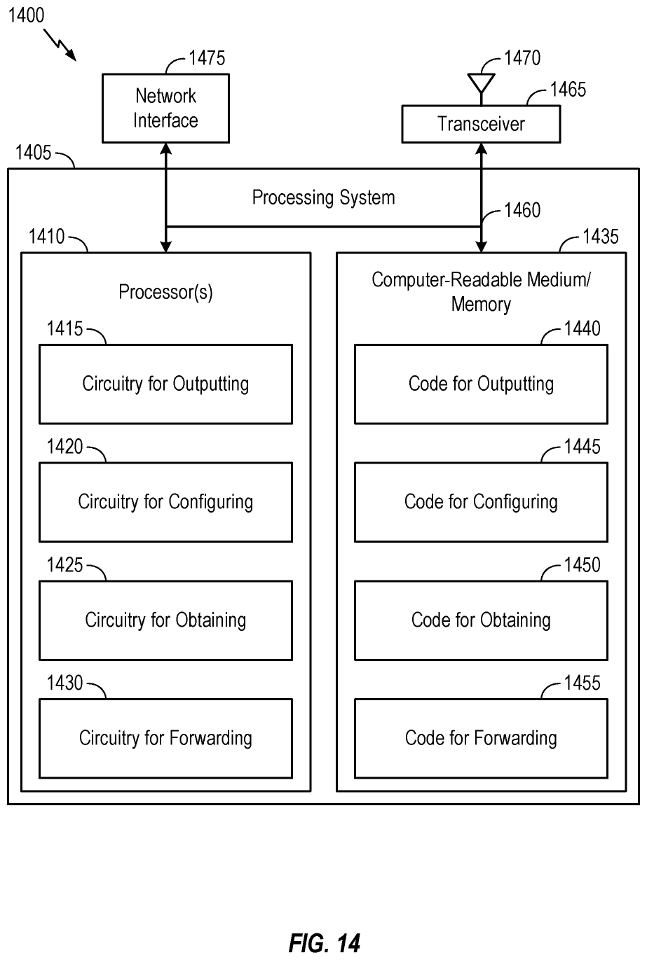

Method 1100 begins at step 1105 with outputting downlink control information (DCI) for transmission to a repeater via a backhaul link, the DCI indicating a time period for beam management. In some cases, the operations of this step refer to, or may be performed by, circuitry for outputting and/or code for outputting as described with reference to FIG. 14.

Method 1100 then proceeds to step 1110 with configuring one or more resources for the repeater to perform a beam management procedure with a user equipment (UE). In some cases, the operations of this step refer to, or may be performed by, circuitry for configuring and/or code for configuring as described with reference to FIG. 14.

Method 1100 then proceeds to step 1115 with obtaining an indication of a beam used for communications between the repeater and the UE. In some cases, the operations of this step refer to, or may be performed by, circuitry for obtaining and/or code for obtaining as described with reference to FIG. 14.

In some aspects, the method 1100 further includes obtaining a report from the UE indicating one or more of transmit beams of the repeater. In some cases, the operations of this step refer to, or may be performed by, circuitry for obtaining and/or code for obtaining as described with reference to FIG. 14.

In some aspects, the method 1100 further includes forwarding the report to the repeater. In some cases, the operations of this step refer to, or may be performed by, circuitry for forwarding and/or code for forwarding as described with reference to FIG. 14.

In some aspects, the report further comprises measurements of one or more transmit beams of one or more other repeaters.

In some aspects, the method 1100 further includes outputting signaling to the repeater via the backhaul link, the signaling scheduling the repeater to transmit a downlink transmission to the UE, wherein the signaling indicates the UE. In some cases, the operations of this step refer to, or may be performed by, circuitry for outputting and/or code for outputting as described with reference to FIG. 14.

In some aspects, the signaling indicates the UE via a logical identifier (ID), a configuration ID, or a UE ID associated with the UE.

In some aspects, the method 1100 further includes outputting signaling to the repeater indicating beam training information for predicting a best beam for communicating with the UE based on the beam management procedure. In some cases, the operations of this step refer to, or may be performed by, circuitry for outputting and/or code for outputting as described with reference to FIG. 14.

In some aspects, the method 1100 further includes outputting signaling to the UE indicating beam training information for predicting a best beam for communicating with the repeater based on the beam management procedure. In some cases, the operations of this step refer to, or may be performed by, circuitry for outputting and/or code for outputting as described with reference to FIG. 14.

In some aspects, the method 1100 further includes configuring one or more measurement gaps at the repeater and the UE for performing one or more beam management procedures to train a beam prediction machine learning model. In some cases, the operations of this step refer to, or may be performed by, circuitry for configuring and/or code for configuring as described with reference to FIG. 14.

In some aspects, the method 1100 further includes obtaining signaling a request from the repeater to configure channel state information (CSI) resources for the one or more beam management procedures. In some cases, the operations of this step refer to, or may be performed by, circuitry for obtaining and/or code for obtaining as described with reference to FIG. 14.

In some aspects, the method 1100 further includes obtaining a beam failure recovery request (BFRQ) message, the BFRQ message indicating failure of the beam and indicating a replacement beam. In some cases, the operations of this step refer to, or may be performed by, circuitry for obtaining and/or code for obtaining as described with reference to FIG. 14.

In some aspects, the replacement beam comprises a second downlink beam of the repeater on a same component carrier as the failed beam.

In some aspects, the method 1100 further includes forwarding the BFRQ message to the repeater. In some cases, the operations of this step refer to, or may be performed by, circuitry for forwarding and/or code for forwarding as described with reference to FIG. 14.

In some aspects, the replacement beam comprise a downlink beam of another repeater.

In some aspects, obtaining the BFRQ message comprises obtaining the BFRQ message from the UE.

In some aspects, obtaining the BFRQ message comprises obtaining the BFRQ message forwarded by the repeater from the UE.

In some aspects, the method 1100 further includes outputting signaling for transmission to the repeater indicating for the repeater to release the UE. In some cases, the operations of this step refer to, or may be performed by, circuitry for outputting and/or code for outputting as described with reference to FIG. 14.

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

### Example Communications Device(s)

FIG. 12 depicts aspects of an example communications device 1200. In some aspects, communications device 1200 is a user equipment, such as UE 104 described above with respect to FIGS. 1 and 3. In some aspects, communications device 1200 is a network entity, such as BS 102 of FIGS. 1 and 3, or a disaggregated base station as discussed with respect to FIG. 2.

The communications device 1200 includes a processing system 1202 coupled to the transceiver 1254 (e.g., a transmitter and/or a receiver). In some aspects (e.g., when communications device 1200 is a network entity), processing system 1202 may be coupled to a network interface 1258 that is configured to obtain and send signals for the communications device 1200 via communication link(s), such as a backhaul link, midhaul link, and/or fronthaul link as described herein, such as with respect to FIG. 2. The transceiver 1254 is configured to transmit and receive signals for the communications device 1200 via the antenna 1256, such as the various signals as described herein. The processing system 1202 may be configured to perform processing functions for the communications device 1200, including processing signals received and/or to be transmitted by the communications device 1200.

The processing system 1202 includes one or more processors 1204. In various aspects, the one or more processors 1204 may be representative of one or more of receive processor 358, transmit processor 364, TX MIMO processor 366, and/or controller/processor 380, as described with respect to FIG. 3. In various aspects, one or more processors 1204 may be representative of one or more of receive processor 338, transmit processor 320, TX MIMO processor 330, and/or controller/processor 340, as described with respect to FIG. 3. The one or more processors 1204 are coupled to a computer-readable medium/memory 1228 via a bus 1252. In certain aspects, the computer-readable medium/memory 1228 is configured to store instructions (e.g., computer-executable code) that when executed by the one or more processors 1204, cause the one or more processors 1204 to perform the method 900 described with respect to FIG. 9, or any aspect related to it. Note that reference to a processor performing a function of communications device 1200 may include one or more processors 1204 performing that function of communications device 1200.

In the depicted example, computer-readable medium/memory 1228 stores code (e.g., executable instructions), such as code for receiving 1230, code for performing 1232, code for determining 1234, code for communicating 1236, code for obtaining 1238, code for training 1240, code for signaling 1242, code for forwarding 1244, code for sending 1246, code for releasing 1248, and code for transmitting 1250. Processing of the code for receiving 1230, code for performing 1232, code for determining 1234, code for communicating 1236, code for obtaining 1238, code for training 1240, code for signaling 1242, code for forwarding 1244, code for sending 1246, code for releasing 1248, and code for transmitting 1250 may cause the communications device 1200 to perform the method 900 described with respect to FIG. 9, or any aspect related to it.

The one or more processors 1204 include circuitry configured to implement (e.g., execute) the code stored in the computer-readable medium/memory 1228, including circuitry for receiving 1206, circuitry for performing 1208, circuitry for determining 1210, circuitry for communicating 1212, circuitry for obtaining 1214, circuitry for training 1216, circuitry for signaling 1218, circuitry for forwarding 1220, circuitry for sending 1222, circuitry for releasing 1224, and circuitry for transmitting 1226. Processing with circuitry for receiving 1206, circuitry for performing 1208, circuitry for determining 1210, circuitry for communicating 1212, circuitry for obtaining 1214, circuitry for training 1216, circuitry for signaling 1218, circuitry for forwarding 1220, circuitry for sending 1222, circuitry for releasing 1224, and circuitry for transmitting 1226 may cause the communications device 1200 to perform the method 900 described with respect to FIG. 9, or any aspect related to it.

Various components of the communications device 1200 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1254 and the antenna 1256 of the communications device 1200 in FIG. 12. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1254 and the antenna 1256 of the communications device 1200 in FIG. 12.

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to the transceiver 1385 (e.g., a transmitter and/or a receiver). The transceiver 1385 is configured to transmit and receive signals for the communications device 1300 via the antenna 1390, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1345 via a bus 1380. In certain aspects, the computer-readable medium/memory 1345 is configured to store instructions (e.g., computer-executable code) that when executed by the one or more processors 1310, cause the one or more processors 1310 to perform the method 1000 described with respect to FIG. 10, or any aspect related to it. Note that reference to a processor performing a function of communications device 1300 may include one or more processors 1310 performing that function of communications device 1300.

In the depicted example, computer-readable medium/memory 1345 stores code (e.g., executable instructions), such as code for performing 1350, code for detecting 1355, code for sending 1360, code for receiving 1365, code for using 1370, and code for training 1375. Processing of the code for performing 1350, code for detecting 1355, code for sending 1360, code for receiving 1365, code for using 1370, and code for training 1375 may cause the communications device 1300 to perform the method 1000 described with respect to FIG. 10, or any aspect related to it.

The one or more processors 1310 include circuitry configured to implement (e.g., execute) the code stored in the computer-readable medium/memory 1345, including circuitry such as circuitry for performing 1315, circuitry for detecting 1320, circuitry for sending 1325, circuitry for receiving 1330, circuitry for using 1335, and circuitry for training 1340. Processing with circuitry for performing 1315, circuitry for detecting 1320, circuitry for sending 1325, circuitry for receiving 1330, circuitry for using 1335, and circuitry for training 1340 may cause the communications device 1300 to perform the method 1000 described with respect to FIG. 10, or any aspect related to it.

Various components of the communications device 1300 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1385 and the antenna 1390 of the communications device 1300 in FIG. 13. Means for receiving or obtaining may include transceivers 354 and/or antenna(s) 352 of the UE 104 illustrated in FIG. 3 and/or the transceiver 1385 and the antenna 1390 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1465 (e.g., a transmitter and/or a receiver) and/or a network interface 1475. The transceiver 1465 is configured to transmit and receive signals for the communications device 1400 via the antenna 1470, such as the various signals as described herein. The network interface 1475 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1435 via a bus 1460. In certain aspects, the computer-readable medium/memory 1435 is configured to store instructions (e.g., computer-executable code) that when executed by the one or more processors 1410, cause the one or more processors 1410 to perform the method 1100 described with respect to FIG. 11, or any aspect related to it. Note that reference to a processor of communications device 1400 performing a function may include one or more processors 1410 of communications device 1400 performing that function.

In the depicted example, the computer-readable medium/memory 1435 stores code (e.g., executable instructions), such as code for outputting 1440, code for configuring 1445, code for obtaining 1450, and code for forwarding 1455. Processing of the code for outputting 1440, code for configuring 1445, code for obtaining 1450, and code for forwarding 1455 may cause the communications device 1400 to perform the method 1100 described with respect to FIG. 11, or any aspect related to it.

The one or more processors 1410 include circuitry configured to implement (e.g., execute) the code stored in the computer-readable medium/memory 1435, including circuitry such as circuitry for outputting 1415, circuitry for configuring 1420, circuitry for obtaining 1425, and circuitry for forwarding 1430. Processing with circuitry for outputting 1415, circuitry for configuring 1420, circuitry for obtaining 1425, and circuitry for forwarding 1430 may cause the communications device 1400 to perform the method 1100 described with respect to FIG. 11, or any aspect related to it.

Various components of the communications device 1400 may provide means for performing the method 1100 described with respect to FIG. 11, or any aspect related to it. Means for transmitting, sending or outputting for transmission may include transceivers 332 and/or antenna(s) 334 of the BS 102 illustrated in FIG. 3 and/or the transceiver 1465 and the antenna 1470 of the communications device 1400 in FIG. 14. Means for receiving or obtaining may include transceivers 332 and/or antenna(s) 334 of the BS 102 illustrated in FIG. 3 and/or the transceiver 1465 and the antenna 1470 of the communications device 1400 in FIG. 14.

### Example Clauses

Implementation examples are described in the following numbered clauses:

Clause 1: A method for wireless communications by a repeater, comprising: receiving downlink control information (DCI) from a network entity via a backhaul link, the DCI indicating a time period for beam management; performing a beam management procedure with a user equipment (UE) during the time period; determining a beam for communicating with the UE based on the beam management procedure; and communicating with the UE using the beam.

Clause 2: The method of Clause 1, wherein: performing the beam management procedure with the UE comprises: transmitting signals to the UE during the time period with a plurality of different transmit beams using downlink beam sweeping; and obtaining a report from the UE indicating one or more of the transmit beams; and determining the beam for communicating with the UE comprises determining a beam based on the report from the UE.

Clause 3: The method of Clause 2, wherein obtaining the report from the UE indicating the one or more of the transmit beams comprises receiving the report from the UE in a physical uplink control channel (PUCCH).

Clause 4: The method of Clause 2, wherein obtaining the report from the UE indicating the one or more of the transmit beams comprises receiving the report forwarded by the network entity via the backhaul link.

Clause 5: The method of any one of Clauses 1-4, wherein: performing the beam management procedure with the UE comprises measuring signals from the UE during the time period with a plurality of different transmit beams using uplink beam sweeping; and determining the beam for communicating with the UE comprises determining a beam based on the measuring.

Clause 6: The method of Clause 5, wherein the signals from the UE comprises sounding reference signals (SRSs).

Clause 7: The method of any one of Clauses 1-6, further comprising: receiving signaling from the network entity via the backhaul link, the signaling scheduling the repeater to transmit a downlink transmission to the UE, wherein the signaling indicates the UE; and communicating with the UE using the beam comprises transmitting the downlink transmission to the UE using the beam based on the signaling indicating the UE.

Clause 8: The method of Clause 7, wherein the signaling indicates the UE via a logical identifier (ID), a configuration ID, or a UE ID associated with the UE.

Clause 9: The method of any one of Clauses 1-8, wherein the determining the beam for communicating with the UE comprises determining the beam using a machine learning model.

Clause 10: The method of Clause 9, further comprising receiving beam measurement information from the network entity, wherein the determining the beam for communicating with the UE comprises using the machine learning model comprises: inputting the beam measurement information to the machine learning model; and obtaining a predicted beam for communicating with the UE from the machine learning model in response to the inputting.

Clause 11: The method of Clause 9, further comprising: performing, during one or more measurement gaps, one or more beam management procedures with the UE; and training the machine learning model based on the one or more beam management procedures.

Clause 12: The method of Clause 11, further comprising signaling a request to the network entity for channel state information (CSI) resources for the one or more beam management procedures.

Clause 13: The method of any one of Clauses 1-12, wherein the determining the beam for communicating with the UE comprises: reporting beam training data to the network entity; and receiving signaling from the network entity indicating the beam.

Clause 14: The method of any one of Clauses 1-13, further comprising:
obtaining a beam failure recovery request (BFRQ) message from the UE, the BFRQ message indicating failure of the beam and indicating a replacement beam.

Clause 15: The method of Clause 14, wherein the replacement beam comprises a second beam of the repeater on a same component carrier as the failed beam.

Clause 16: The method of Clause 14, wherein obtaining the BFRQ message from the UE comprises receiving the BFRQ message forwarded by the network entity.

Clause 17: The method of Clause 14, wherein obtaining the BFRQ message from the UE comprises receiving the BFRQ message from the UE.

Clause 18: The method of Clause 17, further comprising forwarding the BFRQ message to the network entity.

Clause 19: The method of Clause 14, further comprising sending a random access channel (RACH) response message to the UE using the replacement beam.

Clause 21: The method of Clause 14, wherein obtaining the BFRQ message from the UE comprises receiving the BFRQ message from the UE on a first component carrier, wherein the failed beam is on a second component carrier.

Clause 20: The method of any one of Clauses 1-19, further comprising: receiving signaling from the network entity indicating for the repeater to release the UE; and releasing the UE in response to the signaling.

Clause 22: The method of any one of Clauses 1-21, further comprising signaling the network entity an indication of the determined beam.

Clause 23: The method of any one of Clauses 1-22, wherein the determined beam comprises a coarse beam, and further comprising determining one or more refined beams within the coarse beam.

Clause 24: The method of any one of Clauses 1-23, further comprising transmitting one or more channel state information reference signals (CSI-RSs) to the UE as part of a UE receive beam refinement procedure.

Clause 25: The method of any one of Clauses 1-24, further comprising transmitting first one or more phase tracking reference signals (PTRSs) to the UE, wherein the first one or more PTRSs are associated with a first beam for data transmission to the UE.

Clause 26: The method of Clause 25, further comprising transmitting, after determining the beam, second one or more PTRSs to the UE, wherein the second one or more PTRSs are associated with the determined beam.

Clause 27: The method of Clause 26, wherein the first one or more PTRSs and the second one or more PTRSs are associated with a same coarse beam.

Clause 28: The method of any one of Clauses 1-27, further comprising transmitting one or more synchronization signal blocks (SSBs).

Clause 29: A method for wireless communications by a user equipment, comprising: performing a beam management procedure with a repeater; detecting a failure of a beam used for communicating with the repeater; and sending a beam failure recovery request (BFRQ) message indicating failure of the beam and indicating a replacement beam.

Clause 30: The method of Clause 29, wherein performing the beam management procedure with the repeater comprises: receiving signals from the repeater, during a time period, transmitted with a plurality of different transmit beams using a same receive beam; and sending a report indicating one or more of the plurality of different transmit beams.

Clause 31: The method of Clause 30, wherein sending the report comprises sending the report to the repeater.

Clause 32: The method of Clause 30, wherein sending the report comprises sending the report to a base station associated with the repeater.

Clause 33: The method of Clause 32, wherein the report further comprises measurements of beams associated with one or more other repeaters.

Clause 34: The method of Clause 30, wherein sending the report comprises sending the report in a physical uplink control channel (PUCCH).

Clause 35: The method of any one of Clauses 29-34, wherein performing the beam management procedure with the repeater comprises sending signals to the repeater, during a time period, with a plurality of different transmit beams using uplink beam sweeping.

Clause 36: The method of Clause 35, wherein the signals comprise sounding reference signals (SRSs).

Clause 37: The method of any one of Clauses 29-36, wherein performing the beam management procedure includes: inputting beam measurement information to a machine learning model; and obtaining a predicted beam for communicating with the repeater from the machine learning model in response to the inputting.

Clause 38: The method of Clause 37, further comprising: receiving beam training information from a base station associated with the repeater; and using the beam training information during the beam management procedure to predict a best beam for communicating with the repeater.

Clause 39: The method of Clause 37, further comprising: performing, during one or more measurement gaps, one or more beam management procedures with the repeater; and training the machine learning model based on the one or more beam management procedures.

Clause 40: The method of any one of Clauses 29-39, wherein sending the BFRQ message comprises sending the BFRQ message to the repeater.

Clause 41: The method of Clause 40, wherein the replacement beam comprises a second beam of the repeater on a same component carrier as the failed beam.

Clause 42: The method of Clause 40, wherein the sending the BFRQ message comprises sending the BFRQ message to the repeater on a first component carrier, wherein the failed beam is on a second component carrier.

Clause 43: The method of any one of Clauses 29-42, wherein sending the BFRQ message comprises sending the beam failure message to a base station associated with the repeater.

Clause 44: The method of Clause 43, further comprising sending the BFRQ message to the repeater.

Clause 45: The method of Clause 43, wherein the replacement beam comprises a beam of another repeater.

Clause 46: The method of Clause 45, further comprising sending a random access channel (RACH) request message to the other repeater indicating the replacement beam.

Clause 47: The method of any one of Clauses 29-46, wherein the beam comprises a coarse beam, and further comprising determining one or more refined beams within the coarse beam.

Clause 48: The method of Clause 47, further comprising receiving one or more channel state information reference signals (CSI-RSs) from the repeater as part of a UE receive beam refinement procedure.

Clause 49: The method of Clause 47, further comprising receiving first one or more phase tracking reference signals (PTRSs) from the repeater, wherein the first one or more PTRSs are associated with a first beam for data transmission to the UE.

Clause 50: The method of Clause 49, further comprising receiving second one or more PTRSs from the repeater, wherein the second one or more PTRSs are associated with the determined beam.

Clause 51: The method of Clause 50, wherein the first one or more PTRSs and the second one or more PTRSs are associated with a same coarse beam.

Clause 52: A method for wireless communications by a network entity, comprising: outputting downlink control information (DCI) for transmission to a repeater via a backhaul link, the DCI indicating a time period for beam management; configuring one or more resources for the repeater to perform a beam management procedure with a user equipment (UE); and obtaining an indication of a beam used for communications between the repeater and the UE.

Clause 53: The method of Clause 52, further comprising obtaining a report from the UE indicating one or more of transmit beams of the repeater.

Clause 54: The method of Clause 53, further comprising forwarding the report to the repeater.

Clause 55: The method of Clause 53, wherein the report further comprises measurements of one or more transmit beams of one or more other repeaters.

Clause 56: The method of any one of Clauses 52-55, further comprising: outputting signaling to the repeater via the backhaul link, the signaling scheduling the repeater to transmit a downlink transmission to the UE, wherein the signaling indicates the UE.

Clause 57: The method of Clause 56, wherein the signaling indicates the UE via a logical identifier (ID), a configuration ID, or a UE ID associated with the UE.

Clause 58: The method of any one of Clauses 52-57, further comprising outputting signaling to the repeater indicating beam training information for predicting a best beam for communicating with the UE based on the beam management procedure.

Clause 59: The method of any one of Clauses 52-58, further comprising outputting signaling to the UE indicating beam training information for predicting a best beam for communicating with the repeater based on the beam management procedure.

Clause 60: The method of any one of Clauses 52-59, further comprising configuring one or more measurement gaps at the repeater and the UE for performing one or more beam management procedures to train a beam prediction machine learning model.

Clause 61: The method of any one of Clauses 52-60, further comprising obtaining signaling a request from the repeater to configure channel state information (CSI) resources for the one or more beam management procedures.

Clause 62: The method of any one of Clauses 52-61, further comprising obtaining a beam failure recovery request (BFRQ) message, the BFRQ message indicating failure of the beam and indicating a replacement beam.

Clause 63: The method of Clause 62, wherein the replacement beam comprises a second beam of the repeater on a same component carrier as the failed beam.

Clause 64: The method of Clause 63, further comprising forwarding the BFRQ message to the repeater.

Clause 65: The method of Clause 62, wherein the replacement beam comprise a beam of another repeater.

Clause 66: The method of Clause 62, wherein obtaining the BFRQ message comprises obtaining the BFRQ message from the UE.

Clause 67: The method of Clause 62, wherein obtaining the BFRQ message comprises obtaining the BFRQ message forwarded by the repeater from the UE.

Clause 68: The method of any one of Clauses 52-67, further comprising outputting signaling for transmission to the repeater indicating for the repeater to release the UE.

Clause 69: An apparatus, comprising: a memory comprising executable instructions; and a processor configured to execute the executable instructions and cause the apparatus to perform a method in accordance with any one of Clauses 1-68.

Clause 70: An apparatus, comprising means for performing a method in accordance with any one of Clauses 1-68.

Clause 71: A non-transitory computer-readable medium comprising executable instructions that, when executed by a processor of an apparatus, cause the apparatus to perform a method in accordance with any one of Clauses 1-68.

Clause 72: A computer program product embodied on a computer-readable storage medium comprising code for performing a method in accordance with any one of Clauses 1-68.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A repeater, comprising:
one or more memories storing computer executable code thereon; and
one or more processors coupled with the one or more memories and configured to, individually or collectively, execute the computer executable code and cause the repeater to:
receive downlink control information (DCI) from a network entity via a backhaul link, the DCI indicating a time period for beam management;
perform a beam management procedure with a user equipment (UE) during the time period;
determine a beam for communicating with the UE based on the beam management procedure; and
communicate with the UE using the beam.

2. The repeater of claim 1, wherein:
performing the beam management procedure with the UE comprises:
transmitting signals to the UE during the time period with a plurality of different transmit beams using downlink beam sweeping; and
decoding a report from the UE indicating one or more of the transmit beams; and
determining the beam for communicating with the UE comprises determining a beam based on the report from the UE.

3. The repeater of claim 1, wherein:
performing the beam management procedure with the UE comprises measuring signals from the UE during the time period with a plurality of different transmit beams using uplink beam sweeping; and
determining the beam for communicating with the UE comprises determining a beam based on the measuring.

4. The repeater of claim 1, wherein the one or more processors are configured to cause the repeater to:
receive signaling from the network entity via the backhaul link, the signaling scheduling the repeater to forward a downlink or an uplink transmission to or from the UE, wherein the signaling indicates an identification information of the UE; and
communicate with the UE using the beam comprises forwarding the downlink or the uplink transmission to or from the UE using the beam based on the signaling indicating the identification information of the UE.

5. The repeater of claim 1, wherein the determining the beam for communicating with the UE comprises determining the beam using a machine learning model.

6. The repeater of claim 5, wherein the one or more processors are configured to cause the repeater to:
receive beam measurement training from the network entity; and
input the beam training information to train the machine learning model.

7. The repeater of claim 5, wherein the one or more processors are configured to cause the repeater to:
input beam measurement information to the machine learning model; and
obtain a predicted beam for communicating with the UE from the machine learning model in response to the inputting.

8. The repeater of claim 5, wherein the one or more processors are configured to cause the repeater to:
during one or more measurement gaps, perform one or more beam management procedures with the UE; and
train the machine learning model based on the one or more beam management procedures.

9. The repeater of claim 1, wherein the one or more processors are configured to cause the repeater to:
report beam training data to the network entity; and
receive signaling from the network entity indicating the beam.

10. The repeater of claim 1, wherein the one or more processors are configured to cause the repeater to obtain a beam failure recovery request (BFRQ) message from the UE, the BFRQ message indicating failure of the beam and indicating a replacement beam.

11. The repeater of claim 10, wherein the replacement beam comprises a second beam of the repeater on a same component carrier as the failed beam.

12. The repeater of claim 10, wherein obtaining the BFRQ message from the UE comprises receiving the BFRQ message forwarded by the network entity.

13. The repeater of claim 10, wherein obtaining the BFRQ message from the UE comprises receiving the BFRQ message from the UE.

14. The repeater of claim 13, wherein the one or more processors are configured to cause the repeater to forward the BFRQ message to the network entity.

15. The repeater of claim 13, wherein receiving the BFRQ message from the UE comprises receiving the BFRQ message from the UE on a first component carrier, wherein the failed beam is on a second component carrier.

16. The repeater of claim 1, wherein the determined beam comprises a coarse beam, and wherein the one or more processors are configured to cause the repeater to:
determine one or more refined beams within the coarse beam; and
switch to the refined beam without signaling the refined beam to the network entity or the user equipment.

17. The repeater of claim 16, wherein the one or more processors are configured to cause the repeater to:
transmit first one or more tracking reference signals (TRSs) to the UE, wherein the first one or more TRSs are associated with a first beam for data transmission to the UE; and
after determining the refined beam, transmit second one or more TRSs to the UE, wherein the second one or more PTRSs are associated with the determined beam, wherein the first one or more TRSs and the second one or more TRSs are associated with a same coarse beam.

18. A user equipment, comprising:
one or more memories storing computer executable code thereon; and
one or more processors coupled with the one or more memories and configured to, individually or collectively, execute the computer executable code and cause the user equipment to:
perform a beam management procedure with a repeater;
detect a failure of a beam used for communicating with the repeater; and
send a beam failure recovery request (BFRQ) message indicating failure of the beam and indicating a replacement beam.

19. The user equipment of claim 18, wherein performing the beam management procedure with the repeater comprises:
receiving signals from the repeater, during a time period, transmitted with a plurality of different transmit beams using a same receive beam; and
sending a report indicating one or more of the plurality of different transmit beams.

20. The user equipment of claim 19, wherein sending the report comprises sending the report to the repeater, a network entity associated with the repeater, or both.

21. The user equipment of claim 19, wherein sending the report comprises sending the report to the network entity, and wherein the report further comprises measurements of beams associated with one or more other repeaters of the network entity.

22. The user equipment of claim 18, wherein performing the beam management procedure with the repeater comprises sending signals to the repeater, during a time period, with a plurality of different transmit beams using uplink beam sweeping.

23. The user equipment of claim 18, wherein performing the beam management procedure includes:
inputting beam measurement information to a machine learning model; and
obtaining a predicted beam for communicating with the repeater from the machine learning model in response to the inputting.

24. The user equipment of claim 18, wherein sending the BFRQ message comprises sending the BFRQ message to the repeater, a network entity associated with the repeater, or both.

25. The user equipment of claim 24, wherein the replacement beam comprises a second downlink beam of the repeater on a same component carrier as the failed beam.

26. The user equipment of claim 24, wherein the sending the BFRQ message comprises sending the BFRQ message to the repeater on a first component carrier, wherein the failed beam is on a second component carrier.

27. The user equipment of claim 18, wherein the replacement beam comprises a beam of another repeater or the network entity.

28. The user equipment of claim 18, further comprising:
receiving first one or more tracking reference signals (TRSs) from the repeater; and
applying a time/frequency tracking or a beam associated with the TRSs after a preconfigured delay.

29. A network entity, comprising:
one or more memories storing computer executable code thereon; and
one or more processors coupled with the one or more memories and configured to, individually or collectively, execute the computer executable code and cause the network entity to:
output downlink control information (DCI) for transmission to a repeater via a backhaul link, the DCI indicating a time period for beam management;
configure one or more resources for the repeater to perform a beam management procedure with a user equipment (UE); and
obtain an indication of a beam used for communications between the repeater and the UE.

30. A method for wireless communications by a repeater, the method comprising:
receiving downlink control information (DCI) from a network entity via a backhaul link, the DCI indicating a time period for beam management;
performing a beam management procedure with a user equipment (UE) during the time period;
determining a beam for communicating with the UE based on the beam management procedure; and
communicating with the UE using the beam.
